(19) United States
(12) Patent Application Publication
(10) Pub. No.: US 2008/0294818 A1
(43) Pub. Date: Nov. 27, 2008

(54) Semiconductor chip

(75) Inventor: Hiroshi Matsunaga, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/153,665

(22) Filed: May 22, 2008

(30) Foreign Application Priority Data
May 24, 2007 (JP) 2007-137931

(51) Int. Cl. G06F 13/00

(52) U.S. Cl. 710/100

(57) ABSTRACT

In a chip, a transfer unit is provided between a physical layer processing unit and a link unit so that multiple lanes of data processed by the physical layer processing unit are transferred to the link unit. The transfer unit includes: multiple transfer unit input terminals inputting the multiple lanes of data processed by the physical layer processing unit; multiple transfer unit output terminals respectively connected to multiple input terminals of the link unit so as to output data input from one of the multiple transfer unit input terminals to each of the multiple input terminals of the link unit; and a switching unit switching the data, which is input from any one of the transfer unit input terminals, to be output from each of the transfer unit output terminals in response to a control signal from a control signal terminal.

### BACKGROUND OF THE INVENTION

1. Field of the Invention

The present invention relates to a semiconductor chip, and more particularly, to an add-in chip that is used by being mounted on a board.

2. Description of Related Art

Conventionally, there has been known a technique of forming a semiconductor device, in which a chip having a built-in circuit performing specific processing and a substrate having the chip mounted thereon are covered with a package made of resin. Input pins and output pins extend from side surfaces of the package, and the input pins and the output pins are respectively connected to input terminals and output terminals of the built-in circuit of the chip. Through those pins, data can be input to and output from the built-in circuit. In general, there are provided a plurality of input pins, output pins, input terminals, and output terminals, and corresponding pins and terminals are connected to each other.

In recent years, as functions of a semiconductor device have become highly sophisticated, a development process therefor tends to be subdivided. Under such circumstances, in a case of developing a semiconductor device, for example, it is likely that a chip and a board having the chip mounted thereon are developed separately. In this case, the development of the chip is carried out assuming that the chip is mounted on the board. Such a chip is also called an add-in chip. FIG. 12 schematically shows a semiconductor device 1 including a chip and a board that are separately developed. Note that the add-in chip is formed so as to be covered with a package, but illustration in the drawings and description of the package are omitted in the following description, for ease of explanation.

The semiconductor device 1 shown in FIG. 12 is an example of a semiconductor device for reception, and includes a board 20 and an add-in chip (hereinafter, referred to simply as “chip”) 30 having a built-in circuit 40. A plurality of pieces of data Sa to Sn are respectively input through a plurality of terminals (board terminals 21a to 21n of FIG. 12) of the board 20. The board terminals 21a to 21n are connected to a plurality of input terminals 31a to 31n of the chip 30, respectively. The input terminals 31a to 31n of the chip 30 are connected to the input terminals 41a to 41n of the built-in circuit 40, respectively, by internal connection. The built-in circuit 40 is developed assuming that certain data is input thereto from each of the input terminals 41a to 41b. In this case, the built-in circuit 40 is developed assuming that, for example, the pieces of data Sa to Sn are input from the input terminals 41a to 41n, respectively.

As shown in FIG. 12, in the semiconductor device 1, the pieces of data Sa to Sn are input to the board terminals 21a to 21n, respectively, and are further input to the input terminals 41a to 41n of the built-in circuit 40, respectively, through the input terminals 31a to 31n.

Incidentally, when the board and the chip are developed separately, an order of data to be input to the board is not necessarily the same as an order requested by the built-in circuit. FIG. 13 schematically shows a semiconductor device 2 in a case where the order of data to be input is reverse to the order shown in FIG. 12.

The semiconductor device 2 includes a board 25 and a chip 30. A plurality of board terminals of the board 25 are arranged in an order reverse to that of the board terminals of the board 20 of the semiconductor device 1. In order to input the pieces of data Sa to Sn in the order corresponding to the order of the input terminals 41a to 41n of the built-in circuit 40, as shown in FIG. 13, it is necessary that lines, which connect the board terminals 21a to 21n of the board 25 to the input terminals 31a to 31n of the chip 30, respectively, intersect with each other. Alternatively, although not shown, to prevent the lines, which connect the board terminals 21a to 21n of the board 25 to the input terminals 31a to 31n of the chip 30, respectively, from intersecting with each other, it is necessary that lines, which connect the input terminals 31a to 31n of the chip 30 to the input terminals 41a to 41n of the built-in circuit 40, respectively, intersect with each other.

Further, when the chip is mounted on the board, due to the physical structure of each of the board and the chip, it is necessary for the chip to be flipped over and mounted on the board in some cases. FIGS. 14 and 15 schematically show a semiconductor device 3 and a semiconductor device 4, respectively, illustrating this case.

The board 20 and the chip 30 forming the semiconductor device 3 shown in FIG. 14 are identical with those of the semiconductor device 1 shown in FIG. 12. However, the chip 30 is flipped over and mounted on the board 20. Accordingly, to order to input certain data to the input terminals 41a and 41n of the built-in circuit 40 of the chip 30, it is necessary that the lines, which connect the board terminals 21a to 21n of the board 25 to the input terminals 31a to 31n of the chip 30, respectively, intersect with each other. Alternatively, as shown in the semiconductor device 4 of FIG. 15, to prevent the lines, which connect the board terminals 21a to 21n of the board 20 to the input terminals 31a to 31n of the chip 30, respectively, from intersecting with each other, it is necessary that the lines, which connect the input terminals 31a to 31n of the chip 30 to the input terminals 41a to 41n of the built-in circuit 40, respectively, intersect with each other.

Japanese Unexamined Patent Application Publication No. 04-340253 discloses a technology for switching a connection between terminals (see FIG. 1 of Japanese Unexamined Patent Application Publication No. 04-340253). According to the technology, there is provided a switching circuit between an input terminal of a chip and an input terminal of a built-in circuit of the chip (hereinafter, referred to as “built-in circuit input terminal” so as to be distinguished from input terminal of chip). The switching circuit is provided for each input terminal of the chip, and has two output terminals (first terminal and second terminal) for each input terminal. The switching circuit switches a terminal to be connected to the input terminal of the chip between the first terminal and the second terminal.

The input terminals of the chip, the switching circuits, and the built-in circuit input terminals are arranged in the same numerical order. The built-in circuit terminals are connected to a side of the first terminals of the switching circuit in the same order as the numerical order, and are connected to a side of the second terminals of the switching circuit in the order reverse to the numerical order.

In other words, in a state where each input terminal of the chip is connected to the first terminal of the corresponding switching circuit, the built-in circuit input terminals are connected to the input terminals of the chip in the same order as the numerical order. On the other hand, in a state where each input terminal of the chip is connected to the second terminal of the corresponding switching circuit, the built-in circuit input terminals are connected to the input terminals of the chip in the order reverse to the numerical order.

Such a switching circuit can be applied to the semiconductor device 2 shown in FIG. 13, for example. Specifically, when the switching circuit disclosed in Japanese Unexamined Patent Application Publication No. 04-340253 is provided for each of the input terminals 31a to 31n, between each of the input terminals 31a to 31n of the chip 30 and each of the input terminals 41a to 41n of the built-in circuit 40, the board terminals 21a to 21n can be connected to the input terminals 31a to 31n of the chip 30, respectively, while the lines between the board and the chip are prevented from intersecting with each other.

Further, the above-mentioned configuration is also applied to the semiconductor devices 3 and 4 shown in FIGS. 14 and 15, respectively.

Incidentally, when the technology disclosed in Japanese Unexamined Patent Application Publication No. 04-340253 is applied to the semiconductor device 2 shown in FIG. 13, the lines between the board and the chip are prevented from intersecting with each other. However, connections for internal switching may intersect with each other in some cases due to the switching. When the connections for internal switching intersect with each other, a length of each transfer path for data to be input to the switching circuit and to be output from the switching circuit may vary among a plurality of pieces of data respectively input to a plurality of input terminals of the chip. Accordingly, even when a plurality of pieces of data are respectively input through the input terminals of the chip at the same timing, there arises a problem in that the plurality of pieces of data are output from the switching circuit at different timings.

A plurality of pieces of data to be transmitted with a predetermined synchronized relation are processed by the built-in circuit of the chip, assuming that the synchronized relation among the pieces of data is maintained. Accordingly, when the synchronized relation among the plurality of pieces of data deteriorates due to the switching circuit, the built-in circuit of the chip does not operate normally. Further, in recent years, there has been a demand for a higher data transmission speed, a high-speed data transmission technology such as PCI Express (PCI: Peripheral Component Interconnect) has been put to practical use. To meet the demand for the high-speed data transmission, functions of a semiconductor device are becoming highly sophisticated, and there is also provided a functional block operating with a high operating frequency in the built-in circuit of the chip.

Therefore, there arises a problem in that, when the above-mentioned switching circuit is provided in a chip, it is difficult to perform the switching with a frequency corresponding to the high operating frequency of the built-in circuit. In some cases, the switching is not satisfactorily performed, and there is a fear that the semiconductor device may cause a malfunction.

### SUMMARY

In one embodiment of the present invention, there is provided a semiconductor chip. The semiconductor chip includes: a first processing unit; a second processing unit operating with a frequency lower than an operating frequency of the first processing unit; a transfer unit provided between the first processing unit and the second processing unit and transferring a plurality of pieces of data between the first processing unit and the second processing unit; and a control signal terminal inputting a control signal to the transfer unit. The transfer unit includes: a plurality of transfer unit input terminals respectively inputting the plurality of pieces of data from a transmission-side processing unit which is a transmission side of one of the first processing unit and the second processing unit; a plurality of transfer unit output terminals respectively corresponding to the plurality of transfer unit input terminals, respectively, and outputting the plurality of pieces of data input from the corresponding transfer unit input terminals to a reception-side processing unit which is a reception side of one of the first processing unit and the second processing unit; and a switching unit switching a correspondence relation between the plurality of transfer unit input terminals and the plurality of transfer unit output terminals in response to the control signal from the control signal terminal.

In another embodiment of the present invention, there is provided a semiconductor device. The semiconductor chip includes: a transfer unit; and a control signal terminal inputting a control signal to the transfer unit. The transfer unit includes: a plurality of transfer unit input terminals respectively inputting a plurality of pieces of data; a plurality of transfer unit output terminals respectively corresponding to the plurality of transfer unit input terminals, respectively, and outputting the plurality of pieces of data input from the corresponding transfer unit input terminals; a switching unit switching a correspondence relation between the plurality of transfer unit input terminals and the plurality of transfer unit output terminals in response to the control signal from the control signal terminal; and a timing correction unit. The timing correction unit corrects a transfer time according to the switching by the switching unit so that the transfer time for transferring data through transfer paths between the plurality of transfer unit input terminals and the plurality of transfer unit output terminals corresponding to the plurality of transfer unit input terminals is set to be constant with respect to the plurality of pieces of data.

Note that the semiconductor chip replaced by a method, a system, or a program can be effective as an embodiment of the present invention.

With the technology of the present invention, in a case of switching a connection between terminals of a semiconductor device, it is possible to prevent the semiconductor device from causing a malfunction due to the switching.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a chip according to a first embodiment of the present invention;

FIG. 2 is a diagram showing a transfer unit of the chip shown in FIG. 1;

FIG. 3 is a diagram showing a semiconductor device to which the chip shown in FIG. 1 is applied;

FIG. 4 is a diagram showing another semiconductor device to which the chip shown in FIG. 1 is applied;

FIG. 5 is a diagram showing a chip according to a second embodiment of the present invention;

FIG. 6 is a diagram showing a chip according to a third embodiment of the present invention;

FIG. 7 is an explanatory diagram of a semiconductor device to which the chip shown in FIG. 1 can be applied;

FIG. 8 is an explanatory diagram of another semiconductor device to which the chip shown in FIG. 1 can be applied;

FIG. 9 is an explanatory diagram of still another semiconductor device to which the chip shown in FIG. 1 can be applied;

FIG. 10 is an explanatory diagram of yet another semiconductor device to which the chip shown in FIG. 1 can be applied;

FIG. 11 is an explanatory diagram of further another semiconductor device to which the chip shown in FIG. 1 can be applied;

FIG. 12 is a diagram for explaining a problem of a semiconductor device of a related art;

FIG. 13 is a diagram for explaining a problem of another semiconductor device of a related art;

FIG. 14 is a diagram for explaining a problem of still another semiconductor device of a related art; and

FIG. 15 is a diagram for explaining a problem of yet another semiconductor device of a related art.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the present invention will be described with reference to the drawings.

### First Embodiment

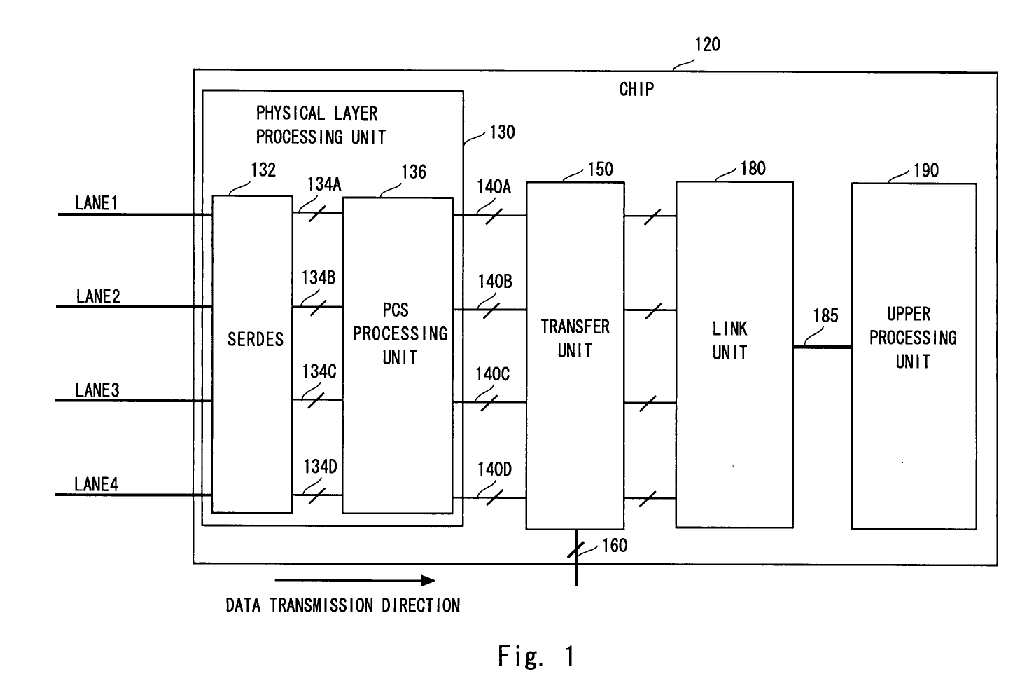

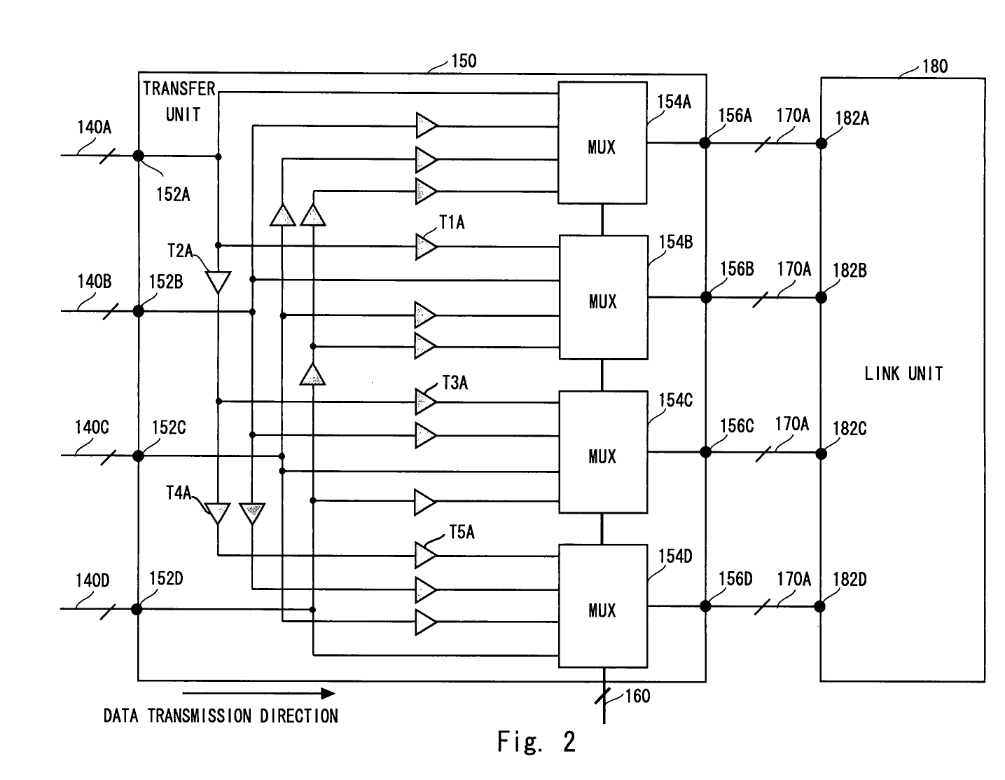

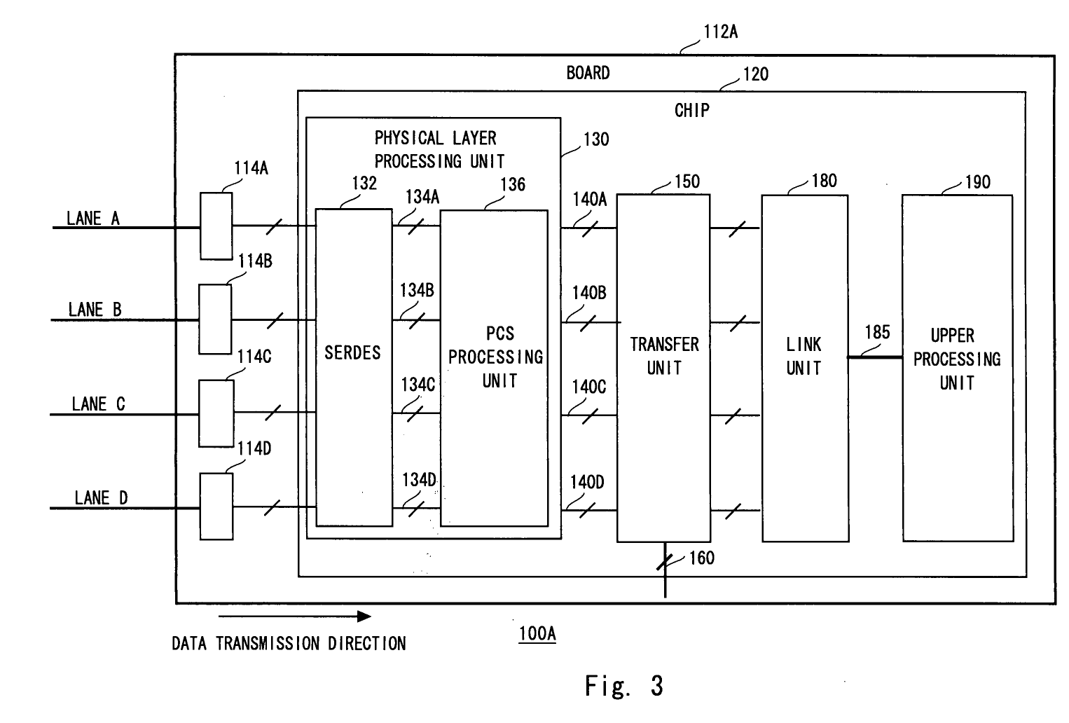

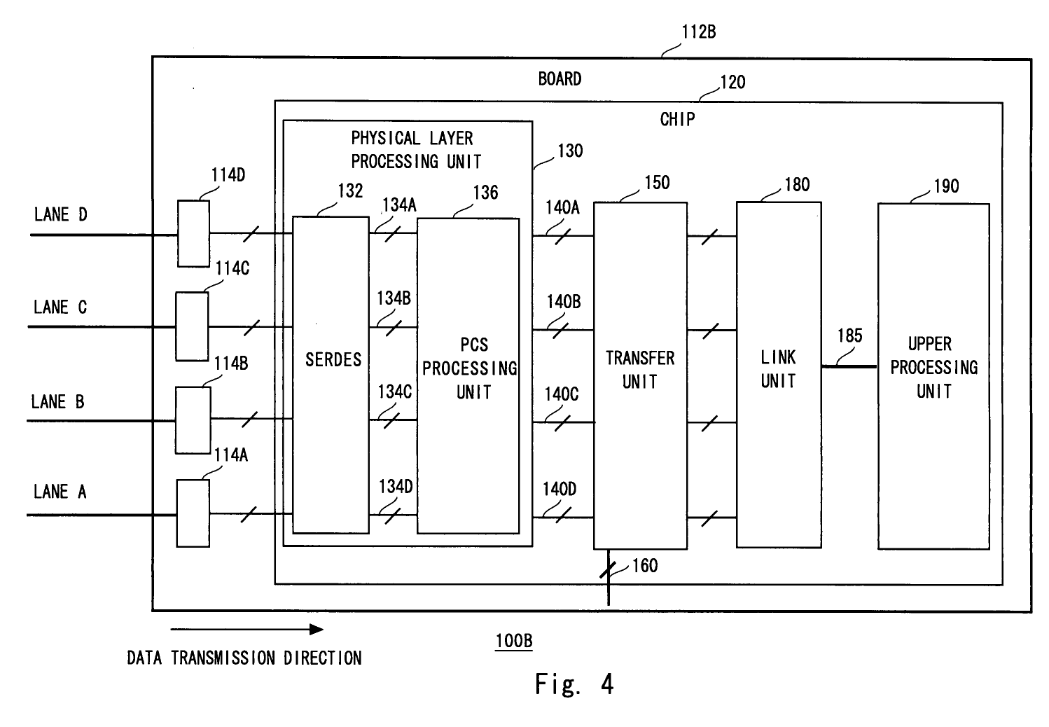

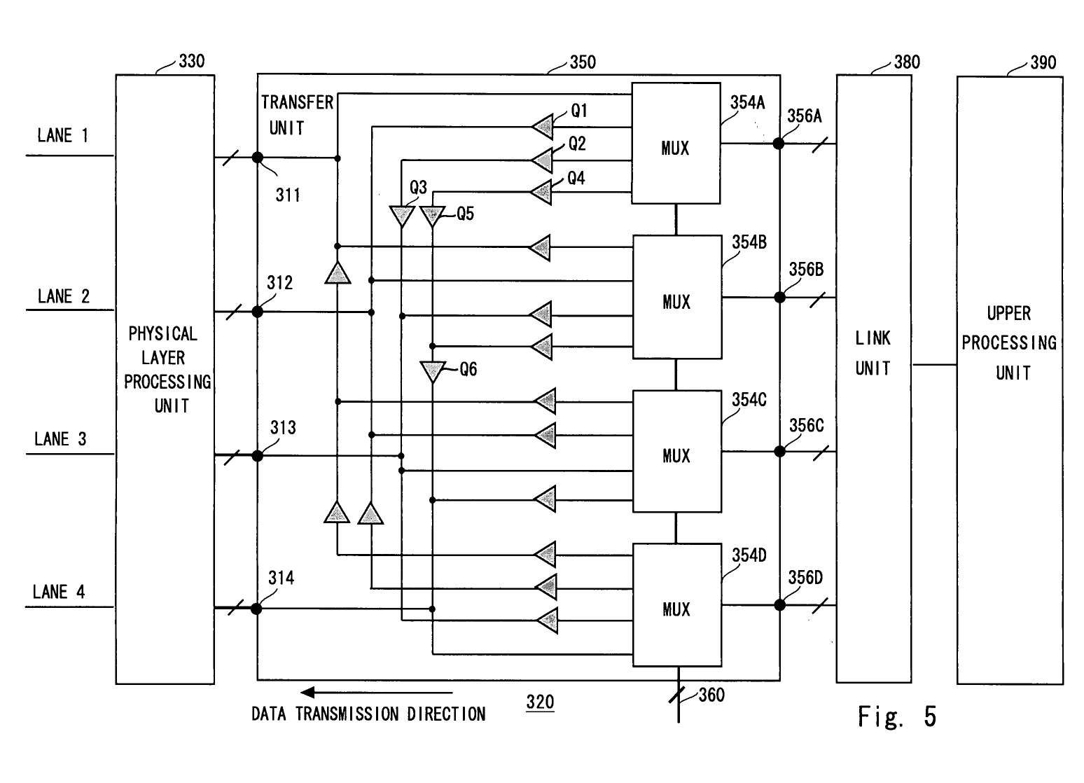

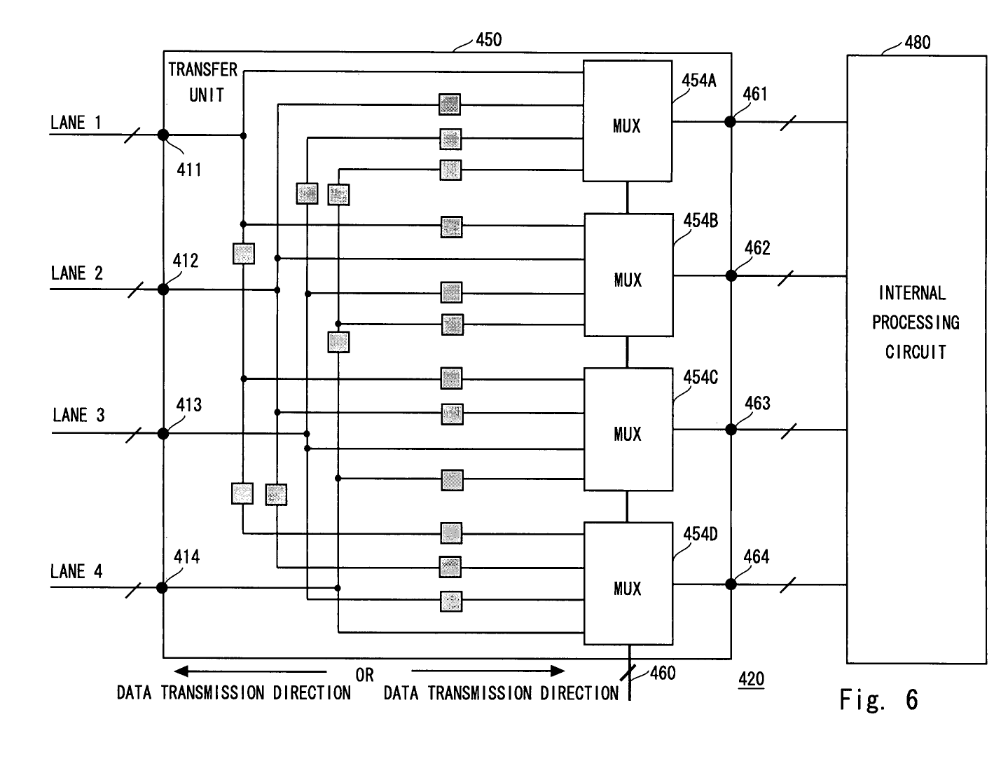

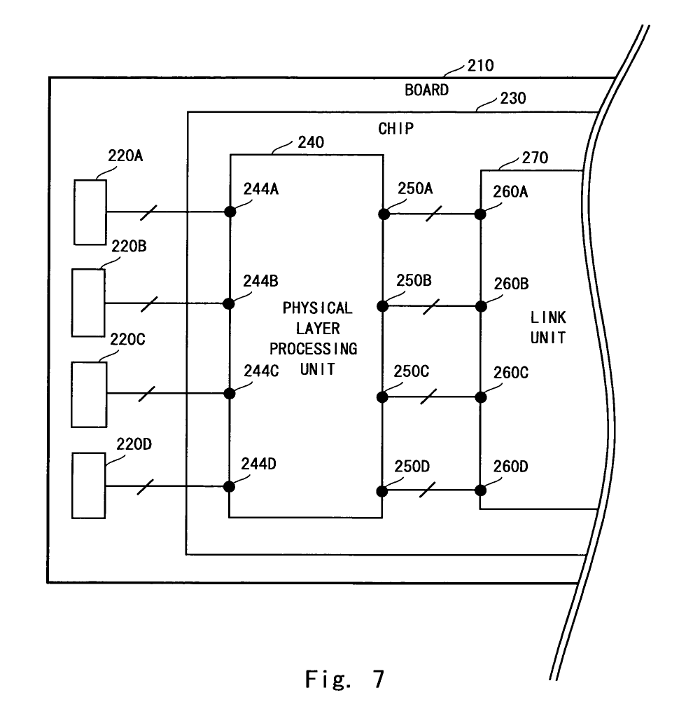

FIG. 1 shows a semiconductor chip 120 according to a first embodiment of the present invention. The chip 120, which is compliant with PCI Express, receives and processes data for each lane. In this case, the chip 120 supports, for example, four lanes, that is, Lane 1, Lane 2, Lane 3, and Lane 4.

In the semiconductor device compliant with PCI Express, circuits receiving data from an outside of the circuits and circuits transmitting data to the outside of the circuits may be partially independent from each other and partially shared with each other. For example, in general, circuits performing physical layer processing are independent from each other for transmission and reception of data, but circuits performing processing of a link layer and upper layers are shared with each other for transmission and reception of data. For ease of explanation, FIG. 1 shows only circuits for reception, but those circuits are not necessarily used only for reception. For example, a link unit 180 and an upper processing unit 190, which perform processing of the link layer and upper layers, to be described later, can be shared with each other for reception and transmission of data.

Note that, according to the PCI Express specification, data is converted into a serial low-voltage differential signal to be transmitted. Accordingly, data of each lane is transmitted using a pair of lines. For ease of explanation, the lines transmitting data of a single lane are each represented by a single line.

Data of each of Lanes 1 to 4 is serial data, and the SERDES 132 converts the data into 10-bit parallel data. A bit width of input data of a single lane is 2.5 GB, so the SERDES 132 converts the input data of each single lane into 10 pieces of data with a bit width of 250 MB. The SERDES 132 converts data of each lane in this manner, and outputs the converted data to the PCS processing unit 136 through lines 134A to 134D.

The board 112B also has four board terminals 114A to 114D for receiving pieces of data of four lanes, that is, Lanes A to D, and for outputting the received data to the chip 120. The board terminals are arranged so that the data is received in the order of Lane D, Lane C, Lane B, and Lane A from the top. In this case, in the transfer unit 150, the selection of data by the MUXs is switched in response to the control signal from the control signal terminal 160 so that the data is input to the link unit 180 in the order of Lane A, Lane B, Lane C, and Lane D. Accordingly, lines connecting each of the board terminals 114D to 114A to the chip 120 do not intersect with each other.

### Second Embodiment

In other words, the data is input from the link unit 380 in a predetermined order of lanes, but the order of lanes of data output from the physical layer processing unit 330 is controlled by the control signal input from the control signal terminal 360. As a result, any combinations of Lanes 1 to 4, for example, combinations of “Lane A, Lane B, Lane C, and Lane D” and “Lane D, Lane C, Lane B, and Lane A” can be adopted.

### Third Embodiment

Note that, in the chip 420, the transfer unit 450 is provided between the outside and the internal processing circuit 480. Alternatively, when the internal processing circuit 480 can be divided into two processing units having different operating frequencies, it is preferable to provide the transfer unit 450 between the two processing units.

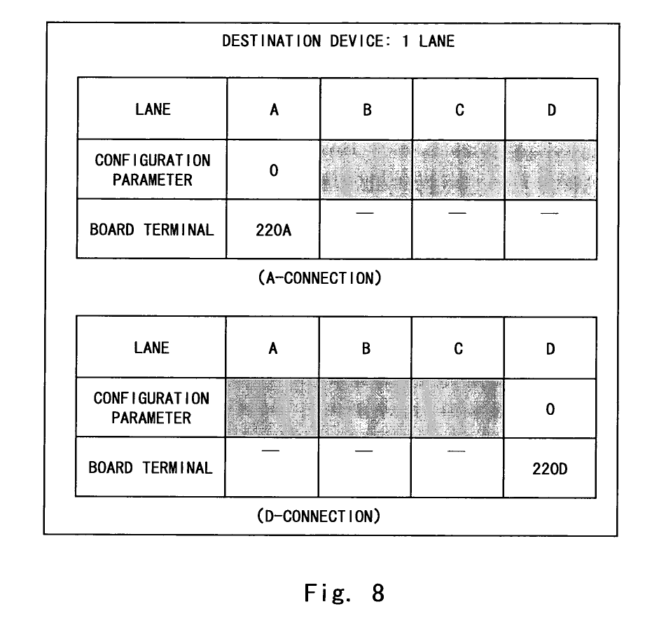

A lower portion of FIG. 8 shows D-connection in which the board terminal 220D is used. In this connection mode, the board terminal 220D and the destination device are connected to each other, and data is input to the link unit 270 through the input terminal 260D. Further, the data is set to be used as the data of Lane A by the configuration parameter of “0”, whereby data communication between the destination device and the semiconductor device can be established.

Incidentally, for example, in a case where the destination device has to be connected to the board terminal 220B or to the board terminal 220C because of limitations of a connector structure, a layout, or the like, even when the destination device is connected to the board terminal 220B or to the board terminal 220C, the data communication therebetween cannot be established due to limitations of the specification of the link unit 270 of the chip 230.

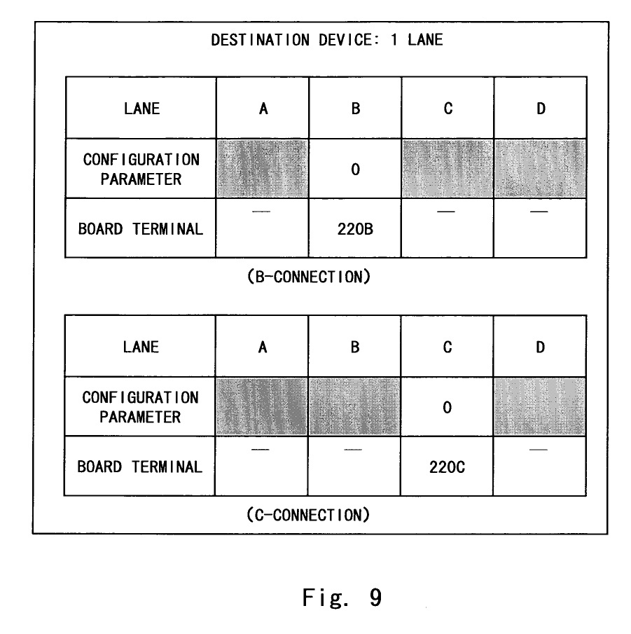

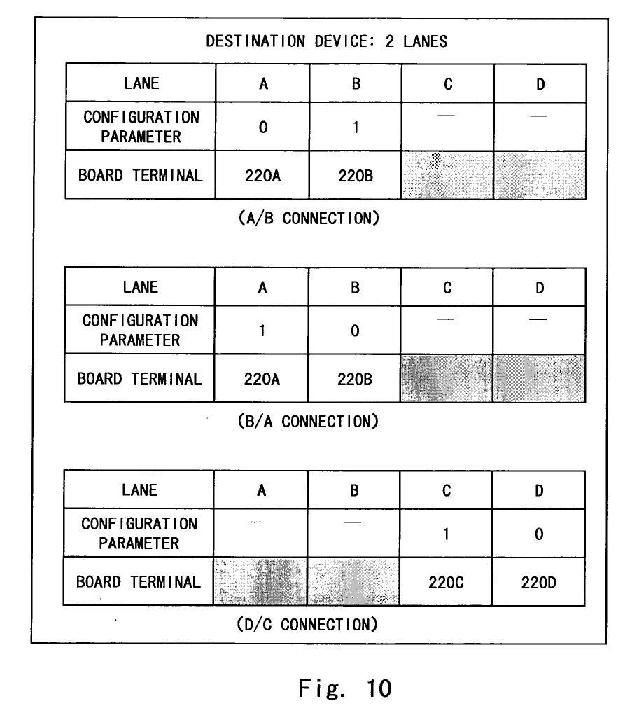

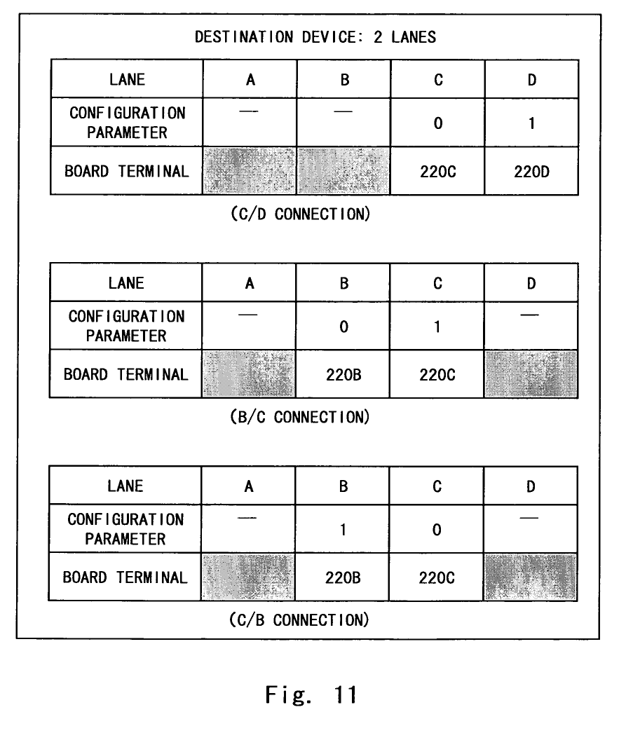

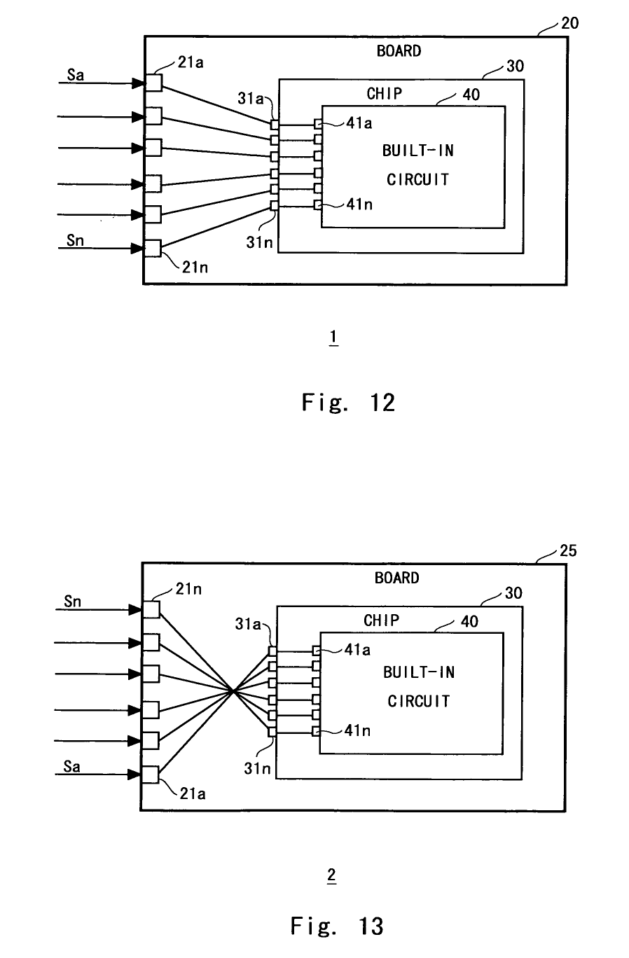

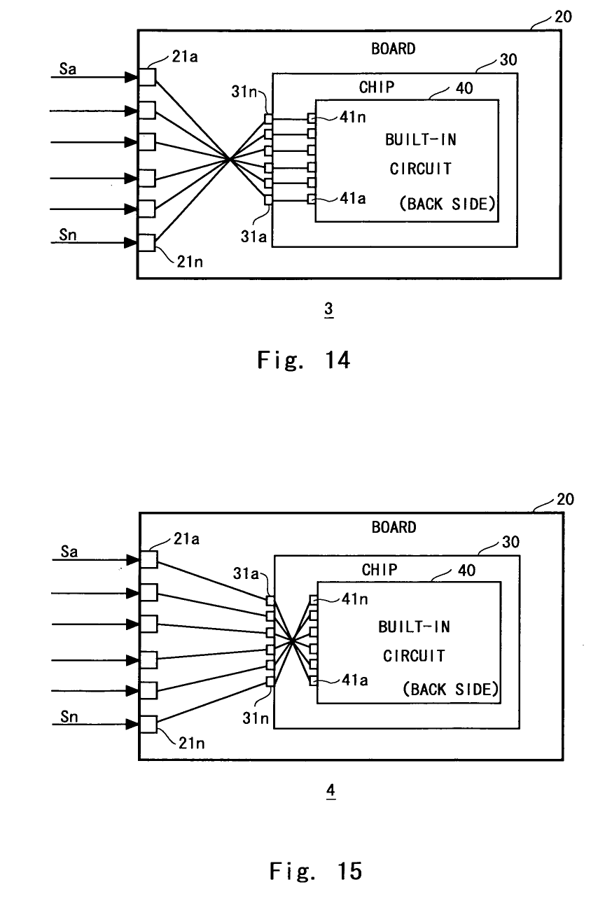

An upper portion of FIG. 9 shows B-connection in which the destination device and the board terminal 220B are connected to each other. In this connection mode, data input to the input terminal 244B is output to the input terminal 260A of the link unit 270 by the transfer unit 150. Further, the data is set to be used as the data of Lane A by the configuration parameter “0”, whereby data communication between the destination device and the semiconductor device can be established.

A lower portion of FIG. 9 shows C-connection in which the destination device and the board terminal 220C are connected to each other. In this connection mode, data input to the input terminal 244C is output to the input terminal 260D of the link unit 270 by the transfer unit 150. In a similar manner, the data is set to be used as the data of Lane A by the configuration parameter “0”, whereby data communication between the destination device and the semiconductor device can be established.

In this manner, by providing the transfer unit 150, four connection modes, which are used in the case of a single lane connection, are additionally provided as shown in FIGS. 8 and 9. Moreover, the flexibility of connection with the destination device can be enhanced.

As in the case of a single lane connection, because of the limitations of the connector structure of the destination device, the layout, and the like, a combination of the board terminals 220B and 220C has to be used for connection in some cases. Also in the case of using the board terminals 220C and 220D, the data of Lane A and the data of Lane B may be input to the board terminals 220C and 220D, respectively. In those cases, the data communication cannot be established simply by connecting the board terminals to the destination device.

In the C/B connection, the board terminals 220B and 220C are each connected to the destination device. By the configuration parameter, data input to the board terminal 220B and data input to the board terminal 220C are set to be used as the data of Lane B and the data of Lane A, respectively. In this case, by the transfer unit 150, the data input to the input terminal 244B is output to the input terminal 260A of the link unit 270, and the data input to the input terminal 244C is output to the input terminal 260B of the link unit 270, whereby the data of Lane B and the data of Lane A are input to the two input terminals 260A and 260B of the link unit 270, respectively. This connection mode corresponds to the B/A connection supported by the link unit 270. Accordingly, the data communication between the destination device and the semiconductor device can be established.

In the above description, there is illustrated the example where the technology of the present invention is applied to the semiconductor device supporting four lanes. The number of lanes is not limited to four, and the present invention can be applied to any semiconductor device supporting an arbitrary number of lanes.

It is apparent that the present invention is not limited to the above embodiments, but may be modified and changed without departing from the scope and spirit of the invention.

What is claimed is:

1. A semiconductor chip, comprising:
a first processing unit;
a second processing unit operating with a frequency lower than an operating frequency of the first processing unit;
a transfer unit provided between the first processing unit and the second processing unit and transferring a plurality of pieces of data between the first processing unit and the second processing unit; and
a control signal terminal inputting a control signal to the transfer unit,
wherein the transfer unit includes:
a plurality of transfer unit input terminals respectively inputting the plurality of pieces of data from a transmission-side processing unit which is a transmission side of one of the first processing unit and the second processing unit;
a plurality of transfer unit output terminals respectively corresponding to the plurality of transfer unit input terminals, respectively, and outputting the plurality of pieces of data input from the corresponding transfer unit input terminals to a reception-side processing unit which is a reception side of one of the first processing unit and the second processing unit; and
a switching unit switching a correspondence relation between the plurality of transfer unit input terminals and the plurality of transfer unit output terminals in response to the control signal from the control signal terminal.

2. The semiconductor chip according to claim 1, wherein the transfer unit further includes a timing correction unit correcting a transfer time according to the switching by the switching unit so that the transfer time for transferring data through transfer paths between the plurality of transfer unit input terminals and the plurality of transfer unit output terminals corresponding to the plurality of transfer unit input terminals is set to be constant with respect to the plurality of pieces of data.

3. The semiconductor chip according to claim 2, wherein:
the timing correction unit comprises a buffer provided to each of the transfer paths for the plurality of pieces of data; and
the number of buffers is increased as the transfer paths increase in length.

4. The semiconductor chip according to claim 1, wherein:
the semiconductor chip is compliant with Peripheral Component Interconnect (PCI) Express;
the plurality of pieces of data respectively correspond to a plurality of lanes;
the transmission-side processing unit comprises a physical layer processing unit performing physical layer processing;
the reception-side processing unit comprises a data link layer processing unit performing data link layer processing for the plurality of pieces of data obtained from the physical layer processing unit;
the transfer unit transfers the plurality of pieces of data obtained from the physical layer processing unit to the data link layer processing unit; and
each of the plurality of transfer unit input terminals and each of the plurality of transfer unit output terminals form a group of a plurality of terminals corresponding to one of the plurality of lanes.

5. The semiconductor chip according to claim 2, wherein:
the semiconductor chip is compliant with Peripheral Component Interconnect (PCI) Express;
the plurality of pieces of data respectively correspond to a plurality of lanes;
the transmission-side processing unit comprises a physical layer processing unit performing physical layer processing;
the reception-side processing unit comprises a data link layer processing unit performing data link layer processing for the plurality of pieces of data obtained from the physical layer processing unit;
the transfer unit transfers the plurality of pieces of data obtained from the physical layer processing unit to the data link layer processing unit; and
each of the plurality of transfer unit input terminals and each of the plurality of transfer unit output terminals form a group of a plurality of terminals corresponding to one of the plurality of lanes.

6. The semiconductor chip according to claim 3, wherein:
the semiconductor chip is compliant with Peripheral Component Interconnect (PCI) Express;
the plurality of pieces of data respectively correspond to a plurality of lanes;
the transmission-side processing unit comprises a physical layer processing unit performing physical layer processing;
the reception-side processing unit comprises a data link layer processing unit performing data link layer processing for the plurality of pieces of data obtained from the physical layer processing unit;
the transfer unit transfers the plurality of pieces of data obtained from the physical layer processing unit to the data link layer processing unit; and
each of the plurality of transfer unit input terminals and each of the plurality of transfer unit output terminals form a group of a plurality of terminals corresponding to one of the plurality of lanes.

7. The semiconductor chip according to claim 1, wherein:
the semiconductor chip is compliant with Peripheral Component Interconnect (PCI) Express;
the plurality of pieces of data respectively correspond to a plurality of lanes;
the transmission-side processing unit comprises a data link layer processing unit performing data link layer processing;
the reception-side processing unit comprises a physical layer processing unit performing physical layer processing for the plurality of pieces of data obtained from the physical layer processing unit;
the transfer unit transfers the plurality of pieces of data obtained from the data link layer processing unit to the physical layer processing unit; and
each of the plurality of transfer unit input terminals and each of the plurality of transfer unit output terminals form a group of a plurality of terminals corresponding to one of the plurality of lanes.

8. The semiconductor chip according to claim 2, wherein:
the semiconductor chip is compliant with Peripheral Component Interconnect (PCI) Express;
the plurality of pieces of data respectively correspond to a plurality of lanes;
the transmission-side processing unit comprises a data link layer processing unit performing data link layer processing;
the reception-side processing unit comprises a physical layer processing unit performing physical layer processing for the plurality of pieces of data obtained from the physical layer processing unit;
the transfer unit transfers the plurality of pieces of data obtained from the data link layer processing unit to the physical layer processing unit; and
each of the plurality of transfer unit input terminals and each of the plurality of transfer unit output terminals form a group of a plurality of terminals corresponding to one of the plurality of lanes.

9. The semiconductor chip according to claim 3, wherein:
the semiconductor chip is compliant with Peripheral Component Interconnect (PCI) Express;
the plurality of pieces of data respectively correspond to a plurality of lanes;
the transmission-side processing unit comprises a data link layer processing unit performing data link layer processing;
the reception-side processing unit comprises a physical layer processing unit performing physical layer processing for the plurality of pieces of data obtained from the physical layer processing unit;
the transfer unit transfers the plurality of pieces of data obtained from the data link layer processing unit to the physical layer processing unit; and
each of the plurality of transfer unit input terminals and each of the plurality of transfer unit output terminals form a group of a plurality of terminals corresponding to one of the plurality of lanes.

10. A semiconductor chip, comprising:
a transfer unit; and
a control signal terminal inputting a control signal to the transfer unit,
wherein the transfer unit includes:
a plurality of transfer unit input terminals respectively inputting a plurality of pieces of data;
a plurality of transfer unit output terminals respectively corresponding to the plurality of transfer unit input terminals and outputting the plurality of pieces of data input from the corresponding transfer unit input terminals;
a switching unit switching a correspondence relation between the plurality of transfer unit input terminals and the plurality of transfer unit output terminals in response to the control signal from the control signal terminal; and
a timing correction unit correcting a transfer time according to the switching by the switching unit so that the transfer time for transferring data through transfer paths between the plurality of transfer unit input terminals and the plurality of transfer unit output terminals corresponding to the plurality of transfer unit input terminals is set to be constant with respect to the plurality of pieces of data.

11. The semiconductor chip according to claim 10, wherein:
the timing correction unit comprises a buffer provided to the transfer paths for each of the plurality of pieces of data; and
the number of buffers is increased as the transfer paths increase in length.

12. The semiconductor chip according to claim 10, further comprising a built-in processing circuit,
wherein the transfer unit is provided between the built-in processing circuit and an outside and transfers the plurality of pieces of data between the built-in processing circuit and the outside.

13. The semiconductor chip according to claim 11, further comprising a built-in processing circuit,
wherein the transfer unit is provided between the built-in processing circuit and an outside and transfers the plurality of pieces of data between the built-in processing circuit and the outside.

14. The semiconductor chip according to claim 10, wherein:
the built-in processing circuit includes:
a first processing unit; and
a second processing unit operating with a frequency lower than an operating frequency of the first processing unit; and
the transfer unit is provided between the first processing unit and the second processing unit and transfers the plurality of pieces of data from a transmission-side processing unit which is a transmission side of one of the first processing unit and the second processing unit, to a reception-side processing unit which is a reception side of one of the first processing unit and the second processing unit.

15. The semiconductor chip according to claim 11, wherein:
the built-in processing circuit includes:
a first processing unit; and
a second processing unit operating with a frequency lower than an operating frequency of the first processing unit; and
the transfer unit is provided between the first processing unit and the second processing unit and transfers the plurality of pieces of data from a transmission-side processing unit which is a transmission side of one of the first processing unit and the second processing unit, to a reception-side processing unit which is a reception side of one of the first processing unit and the second processing unit.

16. The semiconductor chip according to claim 14, wherein:
the semiconductor chip is compliant with Peripheral Component Interconnect (PCI) Express;
the plurality of pieces of data respectively correspond to a plurality of lanes;
the transmission-side processing unit comprises a physical layer processing unit performing physical layer processing;
the reception-side processing unit comprises a data link layer processing unit performing data link layer processing for the plurality of pieces of data obtained from the physical layer processing unit;
the transfer unit transfers the plurality of pieces of data obtained from the physical layer processing unit to the data link layer processing unit; and
each of the plurality of transfer unit input terminals and each of the plurality of transfer unit output terminals form a group of a plurality of terminals corresponding to one of the plurality of lanes.

17. The semiconductor chip according to claim 15, wherein:
the semiconductor chip is compliant with Peripheral Component Interconnect (PCI) Express;
the plurality of pieces of data respectively correspond to a plurality of lanes;
the transmission-side processing unit comprises a physical layer processing unit performing physical layer processing;
the reception-side processing unit comprises a data link layer processing unit performing data link layer processing for the plurality of pieces of data obtained from the physical layer processing unit;
the transfer unit transfers the plurality of pieces of data obtained from the physical layer processing unit to the data link layer processing unit; and
each of the plurality of transfer unit input terminals and each of the plurality of transfer unit output terminals form a group of a plurality of terminals corresponding to one of the plurality of lanes.

18. The semiconductor chip according to claim 14, wherein:
the semiconductor chip is compliant with Peripheral Component Interconnect (PCI) Express;
the plurality of pieces of data respectively correspond to a plurality of lanes;
the transmission-side processing unit comprises a data link layer processing unit performing data link layer processing;
the reception-side processing unit comprises a physical layer processing unit performing physical layer processing for the plurality of pieces of data obtained from the physical layer processing unit;
the transfer unit transfers the plurality of pieces of data obtained from the data link layer processing unit to the physical layer processing unit; and
each of the plurality of transfer unit input terminals and each of the plurality of transfer unit output terminals form a group of a plurality of terminals corresponding to one of the plurality of lanes.

19. The semiconductor chip according to claim 15, wherein:
the semiconductor chip is compliant with Peripheral Component Interconnect (PCI) Express;
the plurality of pieces of data respectively correspond to a plurality of lanes;
the transmission-side processing unit comprises a data link layer processing unit performing data link layer processing;
the reception-side processing unit comprises a physical layer processing unit performing physical layer processing for the plurality of pieces of data obtained from the physical layer processing unit;
the transfer unit transfers the plurality of pieces of data obtained from the data link layer processing unit to the physical layer processing unit; and
each of the plurality of transfer unit input terminals and each of the plurality of transfer unit output terminals form a group of a plurality of terminals corresponding to one of the plurality of lanes.
